(19) United States
(12) Patent Application Publication
(10) Pub. No.: US 2010/0328925 A1
(43) Pub. Date: Dec. 30, 2010

(54) ILLUMINATION DEVICE WITH LED AND A TRANSMISSIVE SUPPORT COMPRISING A LUMINESCENT MATERIAL

(75) Inventors: Christoph Gerard August Hoelen, Eindhoven (NL); Rene Theodorus Wegh, Eindhoven (NL); Lars Rene Christian Waumans, Eindhoven (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/812,976

(22) PCT Filed: Jan. 19, 2009
(86) PCT No.: PCT/IB09/50177

§ 371 Date: Jul. 15, 2010

(30) Foreign Application Priority Data
Jan. 22, 2008 (EP) 08150494.6

(51) Int. Cl. F21V 9/16

(52) U.S. Cl. 362/84

(57) ABSTRACT

The invention provides an illumination device (10) with a light emitting diode (20), a transmissive support (50) comprising a luminescent material (51), and a translucent exit window (60). The luminescent material (51) LED (20) distance dLL is larger than 0 mm, and the luminescent material (51) exit window (60) distance dLW is also larger than 0 mm. With the pro-posed illumination device (10) the lamp may especially look white when it is in the off-state and illuminated with white light. Other advantages are that an intrinsically efficient system may be provided and that a warm white option may be provided.

### FIELD OF THE INVENTION

The invention relates to an illumination device with a transmissive support comprising a luminescent material. The invention further relates to a method for tuning the colour point of the light of the illumination device.

### BACKGROUND OF THE INVENTION

Illumination devices comprising a transmissive support with a luminescent material are known in the art. Transmissive ceramic layers or luminescent ceramics, and their method of preparation, are known in the art. It is for instance referred to U.S. patent application Ser. No. 10/861,172 (US2005/0269582), to U.S. patent application Ser. No. 11/080,801 (US2006/0202105), to WO2006/097868, to WO2007/080555, to US2007/0126017 and to WO2006/114726.

US2005/0269582 for instance, discloses a semiconductor light emitting device combined with a ceramic layer which is disposed in a path of light emitted by the light emitting layer. The ceramic layer is composed of or includes a wavelength converting material such as a luminescent material.

Another specific lamp is disclosed in WO2005/078335 which shows a lighting unit comprising a first light element formed as a conventional light source, a second light element formed as a plurality of LEDs and a lamp cap. According to WO2005/078335 the second light element is formed as a separate LED module with a fitting an a second lamp camp whereby the first and the second light elements are removably attached via the fitting and the second lamp cap, the fitting and second lamp providing electrical end mechanical connection between both light elements.

### SUMMARY OF THE INVENTION

A disadvantage of the prior art systems is that applying a luminescent material layer as exit window or as material visible to a viewer may result in a colour of the exit window, especially a yellow-orange colour, when the system is in off-state. This is the case when the luminescent material-coated window can be viewed directly, e.g. when this window is the light emitting exit window. Such a coloured appearance of a lamp (or luminaire) is often unwanted; a neutral appearance is in general preferred.

Hence, it is an aspect of the invention to provide an alternative illumination device, which preferably further obviates one or more of above-described drawbacks. It is especially an aspect of the invention to provide an illumination device that has a substantially non-coloured appearance in the off state, like in many conventional bulbs with frosted glass.

In a first aspect, the invention provides an illumination device comprising a light emitting diode (LED) arranged to emit LED emission, a transmissive support comprising a luminescent material, wherein the luminescent material is arranged to absorb at least part of the LED emission and emit luminescent material emission, wherein the LED and the luminescent material are arranged to generate light of a predetermined colour, wherein the illumination device further comprises a translucent exit window arranged to transmit at least part of the light, wherein, relative to the LED, the transmissive support is downstream from the LED, thereby providing a luminescent material LED distance (dLL) larger than 0 mm, and the translucent exit window is downstream from the transmissive support, thereby providing a luminescent material exit window distance (dLW) equal to or larger than 0 mm.

With the proposed illumination device the lamp may especially look white when it is in the off-state and illuminated with white light. Other advantages, especially relative to systems wherein the luminescent material is provided on the LED, may be that an intrinsically efficient system (less back reflection/reabsorption) may be provided and that a warm white option (no thermal quenching; “low” flux on luminescent material) may be provided. Further, the illumination device according to the invention is a relatively simple concept (may be based on blue LEDs only, which has the advantage of a relatively easy assembly and driving) and further the option of an adjustable colour temperature is feasible.

Remote luminescent material in LED based light sources seems to be very advantageous with respect to system efficacy, in particular for generation of light with a low colour temperature (warm white). Applying a luminescent material coating on a transmissive support or film may result in high system efficacy because only little light may be reflected back into the LED where it has a rather high chance of being absorbed. Using the luminescent material remote from the LEDs can result in efficacy gains up to about 50% compared to systems with luminescent material in the LED package.

As mentioned above, applying a luminescent material layer at the surface, especially the emitting surface (i.e. downstream surface), of an exit window may result in a rather saturated colour point of that surface when the lamp is off and when it is illuminated with white light. The degree of saturation of the appearing colour of the exit window can be reduced by applying, according to the invention, the luminescent material coating on a transmissive carrier located in between the LEDs and a diffusive, translucent material exit window of the illumination device. The translucent exit window acts as the virtual emission window (for the further optical system, where the light may be further manipulated for e.g. beam shaping). With increasing distance (dLW) between the luminescent material layer and the translucent exit window, the saturation of the colour of the translucent exit window is further reduced. Typically, the saturation can be reduced from about 62% to about 50% by separating the luminescent material layer from the translucent exit window with almost zero spacing (dLW) in between, and can be further reduced down to less than about 20% by increasing the spacing. Further, by spreading the light from the emitting luminescent material layer over a translucent exit window that has a larger upstream surface area (AEW1) than the surface area of the emitting luminescent material layer (i.e. the upstream face area (AS1) of the transmissive support) may also reduce the saturation of the colour of the translucent exit window. Typically, with a surface area ratio (AEW1/AS1) of 8, the saturation is reduced to about 11%, and can be further reduced by further increase of the surface area ratio.

The measures listed above and further herein are based on applying additional scattering or reflection in the system. Surprisingly however, the system efficiency is almost conserved, while in general the addition of more scattering and of more (partly) reflective surfaces in a system cause a very significant reduction of the system efficiency.

### LED and Luminescent Material

In an embodiment, the LED is arranged to emit blue emission and the luminescent material comprises (a) a green luminescent material, arranged to absorb at least part of the blue LED emission and to emit green emission, and (b) a red luminescent material, arranged to absorb at least part of the blue LED emission, or at least part of the green emission, or both at least part of the blue emission and at least part of the green emission and to emit red emission. In this way, the light of a predetermined colour may be white light. Depending upon amongst others LED power, the blue LED emission spectrum, and luminescent material amounts white light of different colour temperatures may be composed.

In another embodiment, the LED is arranged to emit blue emission and wherein the luminescent material comprises (a) a yellow luminescent material, arranged to absorb at least part of the blue emission and to emit yellow emission, and optionally (b) one or more other luminescent materials, arranged to absorb at least part of the blue LED emission, or at least part of the yellow emission, or both at least part of the blue emission and at least part of the yellow emission, and to emit emission at an emission wavelength different from the yellow emission. Also in this way, the light of a predetermined colour may be white light. Depending upon amongst others the blue LED emission spectrum, LED power and luminescent material amounts, white light of different colour temperatures may be composed. In a specific embodiment, the luminescent material, in addition to the yellow luminescent material (a) further comprises (b) a red luminescent material, arranged to absorb at least part of the blue LED emission, or at least part of the yellow emission, or both at least part of the blue emission and at least part of the yellow emission and to emit red emission. This red luminescent material may amongst others be applied to further improve the CRI.

In an embodiment, the illumination device comprises a plurality of light emitting diodes (LEDs) arranged to emit LED emission, such as in the order of 2-100, like 4-64.

The term white light herein, is known to the person skilled in the art. It especially relates to light having a correlated colour temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of colour matching) from the BBL, especially within about 10 SDCM from the BBL, even more especially within about 5 SDCM from the BBL.

The terms “blue light” or “blue emission” especially relates to light having a wavelength in the range of about 410-490 nm. The term “green light” especially relates to light having a wavelength in the range of about 500-570 nm. The term “red light” especially relates to light having a wavelength in the range of about 590-650 nm. The term “yellow light” especially relates to light having a wavelength in the range of about 560-590 nm.

These terms do not exclude that especially the luminescent material may have a broad band emission having emission with wavelength(s) outside the range of for instance about 500-570 nm, about 590-650 nm, and about 560-590 nm respectively. However, the dominant wavelength of emissions of such luminescent materials (or of the LED, respectively) will be found within the herein given ranges, respectively. Hence, the phrase “with a wavelength in the range of” especially indicates that the emission may have a dominant emission wavelength within the specified range.

Especially preferred luminescent materials are selected from garnets and nitrides, especially doped with trivalent cerium or divalent europium, respectively. Embodiments of garnets especially include A₃B₅O₁₂ garnets, wherein A comprises at least yttrium or lutetium and wherein B comprises at least aluminium. Such garnet may be doped with cerium (Ce), with praseodymium (Pr) or a combination of cerium and praseodymium; especially however with Ce. Especially, B comprises aluminium (Al), however, B may also partly comprise gallium (Ga) and/or scandium (Sc) and/or indium (In), especially up to about 10% of Al (i.e. the B ions essentially consist of 90 or more mole % of Al and 10 or less mole % of one or more of Ga, Sc and In); B may especially comprise up to about 10% gallium. In another variant, B and 0 may at least partly be replaced by Si and N. The element A may especially be selected from the group consisting of yttrium (Y), gadolinium (Gd), terbium (Tb) and lutetium (Lu). Further, Gd and/or Tb are especially only present up to an amount of about 20% of A. In a specific embodiment, the garnet luminescent material comprises (Y₁₋ₓ Luₓ)₃B₅O₁₂:Ce, wherein x is equal to or larger than 0 and equal to or smaller than 1.

The term “:Ce”, indicates that part of the metal ions (i.e. in the garnets: part of the “A” ions) in the luminescent material is replaced by Ce. For instance, assuming (Y₁₋ₓ Luₓ)₃Al₅O₁₂:Ce, part of Y and/or Lu is replaced by Ce. This notation is known to the person skilled in the art. Ce will replace A in general for not more than 10%; in general, the Ce concentration will be in the range of 0.1-4%, especially 0.1-2% (relative to A). Assuming 1% Ce and 10% Y, the full correct formula could be (Y_{0.1}Lu_{0.89}Ce_{0.01})₃Al₅O₁₂. Ce in garnets is substantially or only in the trivalent state, as known to the person skilled in the art.

The red luminescent material may in an embodiment comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation, especially in the range of about 0.5-10, more especially in the range of about 0.5-5% relative to the cation(s) it replaces. The term “:Eu”, indicates that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr or Ba.

The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca).

Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50-100%, especially 50-90% Ba and 50-0%, especially 50-10% Sr, such as Ba_{1.5}Sr_{0.5}Si₅N₈:Eu (i.e. 75% Ba; 25% Sr). Here, Eu is introduced and replaces at least part of M i.e. one or more of Ba, Sr, and Ca).

Likewise, the material (Ba,Sr,Ca)AlSiN₃:Eu can also be indicated as MAlSiN₃:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca).

The term luminescent material herein especially relates to inorganic luminescent materials, which are also sometimes indicated as phosphors. These terms are known to the person skilled in the art.

### Transmissive Support

Especially at a non-zero distance from the LED(s) (i.e. especially from the light emitting surface (or dies) from the LED(s), a transmissive support is arranged.

The term “transmissive” herein may in an embodiment refer to transparent and may in another embodiment refer to translucent. These terms are known to the person skilled in the art. Transmissive especially indicates that transmission of light by the transmissive support, especially at least in the blue range, more generally in the whole visible range (i.e. about 380-680 nm), is at least about 20%, more especially at least about 50%, even more especially at least about 80% (under perpendicular irradiation of the transmissive support with the light).

The transmissive support may be self supporting, but it may in an embodiment also be a flexible film, which is for instance stretched (e.g. between LED cavity walls or diffuser cavity walls (see below) of the device). The transmissive support may have a substantially flat shape, like a plate, but may in another embodiment have a substantially convex shape, like for instance a dome.

The transmissive support may in an embodiment comprise an organic material. Preferred organic materials are selected from the group consisting of PET (polyethylene terephthalate), PE (polyethylene), PP (polypropylene), PC (polycarbonate), P(M)MA (poly(methyl)metacrylate), PEN (polyethylene napthalate) and PDMS (polydimethylsiloxane). Polycarbonate gave for instance good results.

However, in another embodiment the transmissive support comprises an inorganic material. Preferred inorganic materials are selected from the group consisting of glasses, (fused) quartz, ceramics, and silicones.

As mentioned above, the transmissive support comprises at least part of the luminescent material. The fact that the transmissive support comprises the luminescent material does not exclude that part of the luminescent material may be arranged elsewhere in the illumination device; however, in a specific embodiment, substantially all luminescent material is comprised by the transmissive support. The phrase “the transmissive support comprises the luminescent material” may relate to a transmissive support selected from the group consisting of a transmissive support wherein the luminescent material is embedded in the transmissive support, a transmissive support that is luminescent material itself, a transmissive support having a downstream coating comprising the luminescent material (side facing to the exit window), a transmissive support having an upstream coating comprising the luminescent material (side facing the LED(s), or a transmissive support comprising both an upstream and downstream coating comprising the luminescent material.

In a preferred embodiment, the transmissive support has an upstream face comprising the coating, wherein the coating comprises at least part of the luminescent material. Such embodiment both benefits from the remote position of the luminescent material (i.e. remote from the LED) and from a relative remote position from the exit window (desaturation of the colour of the exit window when illuminated with white light).

In a specific embodiment, at least part of the luminescent material comprises a transmissive ceramic luminescent material, wherein the transmissive support comprises the transmissive ceramic luminescent material. Hence, in this embodiment, the transmissive support is a luminescent ceramic. Especially suitable luminescent ceramics are based on cerium containing garnets, as described above. Transmissive ceramic layers or luminescent ceramics, and their method of preparation, are known in the art. It is for instance referred to U.S. patent application Ser. No. 10/861,172 (US2005/0269582), to U.S. patent application Ser. No. 11/080,801 (US2006/0202105), or to WO2006/097868, to WO2007/080555, to US2007/0126017 and to WO2006/114726. The documents, and especially the information about the preparation of the ceramic layers provided in these documents, are herein incorporated by reference.

The arrangement of a transmissive ceramic layer comprising the luminescent material instead of arranging the luminescent material to the LED allows a non-zero distance between the luminescent material and the LED. This distance is herein indicated as dLL (luminescent material LED distance). Distance dLL is especially a shortest distance. This means that in an embodiment, any shortest distance between the LED and the luminescent material is equal to or especially larger than 0 mm. In an embodiment the luminescent material LED distance (dLL) is in the range of 0.5-50 mm, especially in the range of 3-20 mm.

The transmissive support has an upstream face with an effective transmissive support upstream face diameter (DS1). Herein the term “effective diameter” is applied. The transmissive support may have a circular shape, having a diameter, but may also have other shapes. The surface area (AS1) of any upstream face may however be applied to calculate the effective diameter (DS1=2√(AS1/π). In a specific embodiment, the ratio dLL/DS1 is in the range of 0.01-1, especially in the range of 0.05-0.5, more especially in the range of 0.1-0.4. In these ranges, especially good results may be obtained.

In a specific embodiment, the luminescent material LED distance (dLL) is adjustable. For instance, with adjusting means such as adjusting screws, the distance between the luminescent material and the LED may be varied. The adjusting means may be used to adjust the distance from the transmissive support, thereby adjusting the luminescent material LED distance.

The illumination device may comprise more than one transmissive supports, with one or more of such transmissive supports comprising luminescent material, possibly with different luminescent material LED distances (dLL). The more than one transmissive supports may for instance comprise different luminescent materials.

### Translucent Exit Window

Especially at a non-zero distance from the luminescent material comprised by the transmissive support, a translucent exit window is arranged. This exit window is arranged to allow illumination device light escape from the illumination device.

The translucent exit window may have a substantially flat shape, like a plate, but may in another embodiment have a substantially convex shape, like for instance a dome.

The translucent exit window may in an embodiment comprise an organic material. Preferred organic materials are selected from the group consisting of PET (polyethylene terephthalate), PE (polyethylene), PP (polypropylene), PC (polycarbonate), P(M)MA (poly(methyl)metacrylate), PEN (polyethylene napthalate) and PDMS (polydimethylsiloxane).

However, in another embodiment the translucent exit window comprises an inorganic material. Preferred inorganic materials are selected from the group consisting of glasses, (fused) quartz, ceramics, and silicones.

The exit window however is translucent. For instance, the above mentioned materials may have intrinsic translucent properties or may be made translucent (for instance by frosting (for instance by sand blasting or acid etching) the material. Such methods are known in the art. The translucent exit window may allow some light to pass through, but the interior (i.e. upstream objects of the illumination device, upstream from the exit window) seen through translucent material are substantially diffused or indistinct.

Unlike other possible configurations, in the illumination device of the invention substantially no luminescent material is arranged at the upstream or downstream face of the exit window. Substantially all luminescent material is comprised by the transmissive support, as described above, thereby providing luminescent material exit window distance (dLW) which is preferably larger than 0 mm. In an embodiment, the luminescent material may be arranged at a downstream face of the transmissive support, and the luminescent material may at least partially be in contact with the exit window, thereby providing a luminescent material exit window distance substantially equal to zero, however, preferably the luminescent material exit window distance (dLW) is larger than zero.

Distance dLW is especially a shortest distance. This means that in an embodiment, any shortest distance between the exit window and the luminescent material is equal to or especially larger than 0 mm. In an embodiment the luminescent material exit window distance (dLW) is in the range of 0.01-100 mm, especially in the range of 1-50 mm, more especially in the range of 10-30 mm. In general, the larger the distance, the less saturated the colour of the translucent exit window may appear.

The translucent exit window has an upstream face with an exit window upstream face area (AEW1). As mentioned above, the transmissive support has an upstream face area (AS1). In a specific embodiment, the exit window and the transmissive support have a surface area ratio AEW1/AS1>1; especially ≧2, more especially in the range of 2-20, even more especially 3-10. Again, in general, the larger the ratio, the less saturated the colour of the translucent exit window may appear. Further, the ratio dLW/DS1 (i.e. the ratio of the luminescent layer exit window distance and the effective transmissive support upstream face diameter) is preferably in the range of 0.01-1, especially in the range of 0.1-0.5. In general, the larger the ratio, the less saturated the colour of the translucent exit window may appear.

### Illumination Device

Relative to the LED(s) the transmissive support is arranged downstream of the LED(s). The transmissive support is preferably arranged in such a way, that substantially all emission generated by the LED(s) is directed in the direction of the transmissive support; i.e. the transmissive support is disposed in a path of light emitted by the LED(s). Hence, in a preferred embodiment, the luminescent material and/or the transmissive support receive substantially all LED emission. Since in an embodiment the distance between the luminescent material and the LED is non-zero, there may be an LED chamber or LED cavity, enclosed by an LED support supporting the LED(s), the transmissive support and optionally LED cavity walls. The luminescent material and/or the transmissive support may receive substantially all LED emission after internal reflection in the LED chamber or LED cavity.

The translucent exit window is arranged downstream from the transmissive support. Hence, the transmissive support has an upstream face directed to the LED(s) and a downstream face directed to the translucent exit window; the translucent exit window has an upstream face directed to the downstream face of the transmissive support and a downstream face, directed to the exterior of the illumination device.

Since in an embodiment the distance between the luminescent material and the exit window is non-zero, there may be an(other) internal chamber or diffuser cavity (herein also indicated as “mixing chamber”), enclosed by the transmissive support, the exit window, and optionally diffuser cavity walls, and optionally the LED support, and optionally the LED cavity walls. In a specific embodiment, between at least part of the luminescent material and the exit window (thus especially in the diffuser cavity), a material is arranged having an index of refraction equal to or smaller than 1.2, such as in the range of 1-1.2, like air, carbon dioxide, helium, argon or vacuum (vacuum is in effect absence of any material).

As mentioned above, this exit window is arranged to allow light escape from the illumination device. However, further optics are not excluded, such as collimators, reflectors, light guides, optical layers etc. to guide or influence the illumination device light, which may be arranged downstream of the exit window.

With the invention, remote luminescent material modules and lamps can be realized that have very high efficiency and good colour rendering, and that now also can appear white or almost colour-neutral when in off-state. The proposed systems with the luminescent material in or on a transmissive support, such as a film, also enable cheap mass production by roll-to-roll processing, and combine homogenisation with efficiency optimization.

The proposed configurations can be applied in large area lighting, ambiance lighting (e.g. light tiles), backlighting (e.g. poster boxes), downlighters, diffuse retrofit lamps such as incandescent (GLS) or TL replacement lamps, and wall washers and, depending on volume and beam constraints, in some spot lamps.

In a specific embodiment, the invention further provides a method for tuning the colour point of the light of the illumination device according to the invention, wherein the luminescent material LED distance (dLL) is adjustable, and wherein, during operation of the light emitting diode (LED), and optionally in the absence of the translucent exit window, the luminescent material LED distance (dLL) is adjusted until a desirable or a predetermined colour point is obtained, more especially until a predetermined colour point is sensed by a sensor arranged to sense the light generated by the LED and the luminescent material. Optionally, the transmissive support may comprise a non-uniform distribution of the luminescent material. For instance, a non-uniform distribution of the phosphor may enhance the tuning capability. Especially, this method for tuning may be applied in adjusting the colour point to a desired or a predetermined value. Here, the term “adjustable” especially relates to a transversal movability of the transmissive support (i.e. in an upstream and/or downstream direction, relative to the LED(s)).

The invention also provides a method for tuning the colour point of the light of an illumination device according to the invention, wherein the transmissive support comprises a non-uniform distribution of the luminescent material, wherein the transmissive support is movable, and wherein, during operation of the light emitting diode (LED) and optionally in the absence of the translucent exit window, the position of the transmissive support relative to the LED is varied until a desirable or a predetermined colour point is obtained, more especially until a predetermined colour point is sensed by a sensor arranged to sense the light generated by the LED and the luminescent material. This method may especially be used to correct for (undesired) luminescent material inhomegeneities in or on the transmissive support. Here, the term “movable” relates to one or more of lateral movability, transversal movability and rotational movability of the transmissive support.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a-1e schematically depict a non-limiting number of possible embodiments of the illumination device of the invention; FIG. 1f schematically depicts embodiments 1a or 1b in a perspective side view;

FIG. 2 depicts the influence of the position of the transmissive support (comprising the luminescent material) on the light output of a specific illumination device (as a function of dLL);

FIG. 3 schematically depicts another embodiment of the illumination device of the invention; and

FIG. 4 depicts the colour appearance of embodiments of the invention in relation to other systems in the off state under office (TL) illumination.

Only the essential elements are depicted. Other elements, like drivers, further optics, like optical filters, collimators, fittings, etc., known to the person skilled in the art, are not depicted in the schematic drawings.

### DESCRIPTION OF PREFERRED EMBODIMENTS

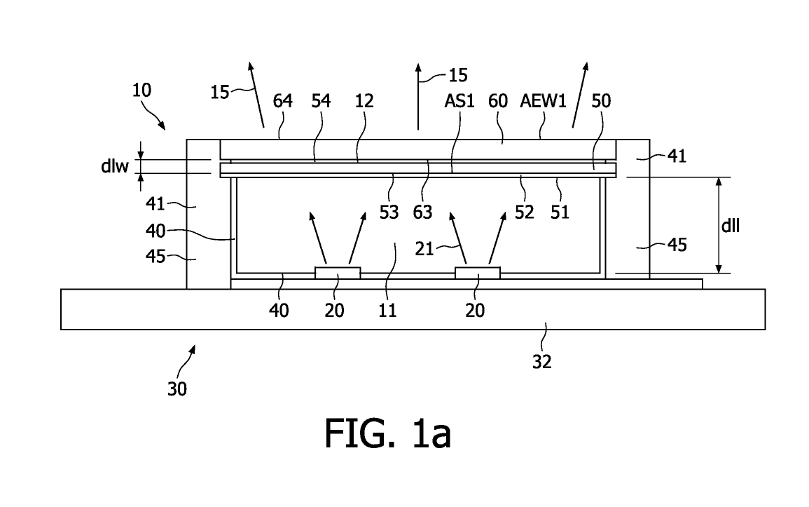

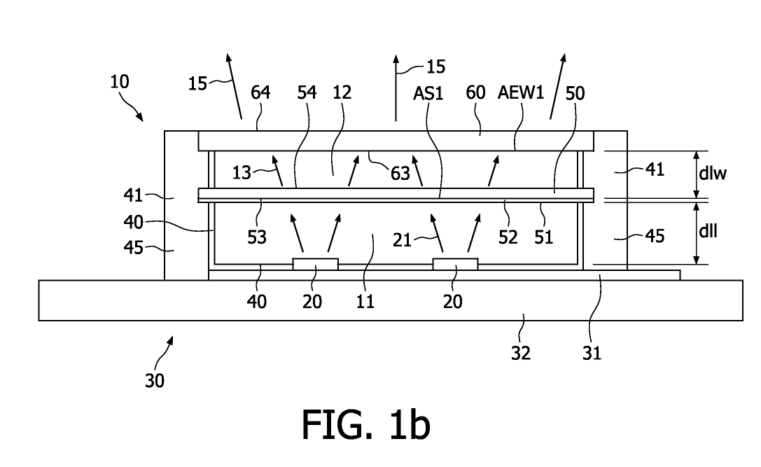

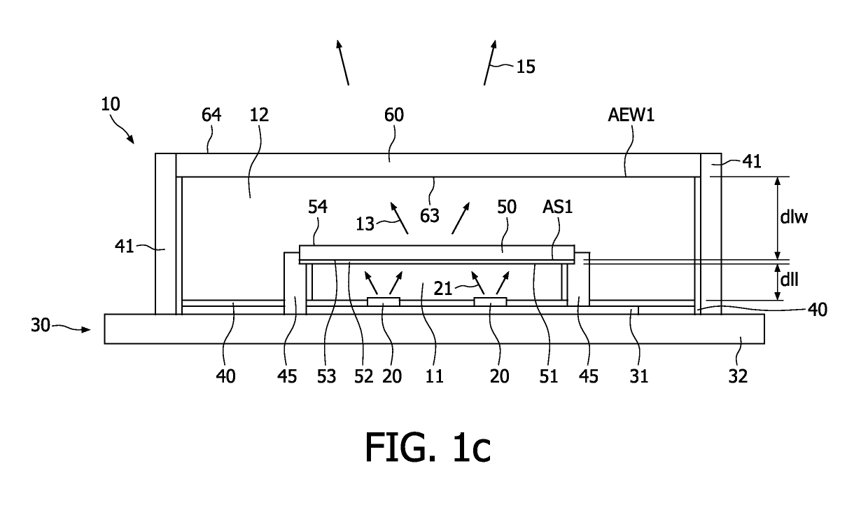

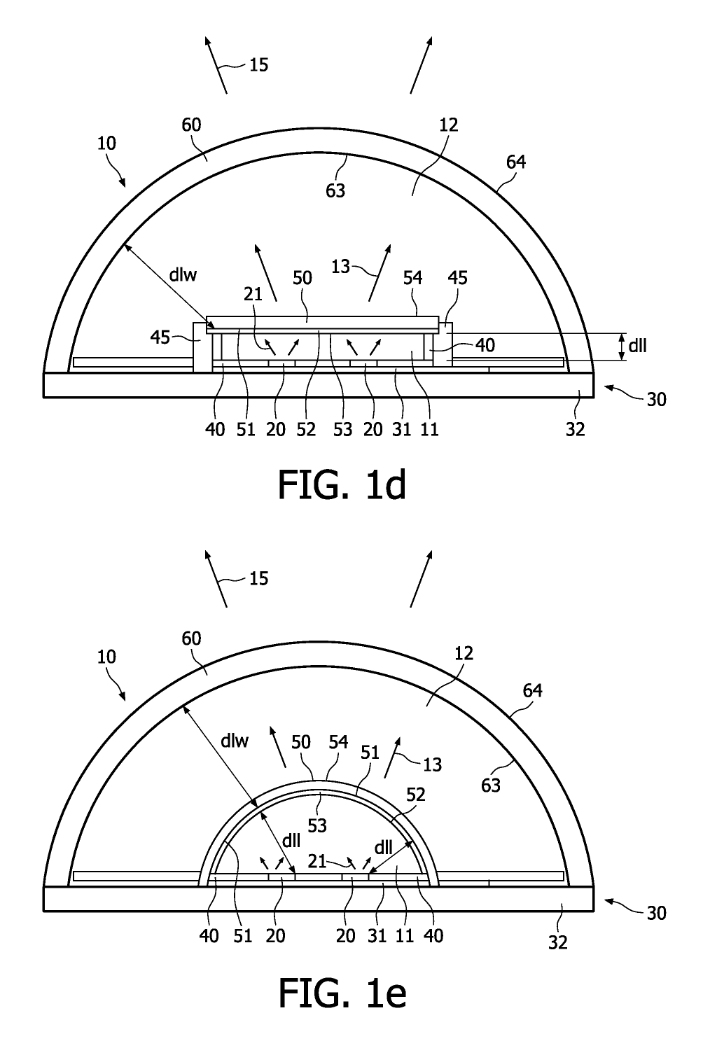

FIG. 1a (and also FIGS. 1b-1e) schematically depicts an illumination device 10 with light emitting diodes 20 arranged to emit LED emission 21. Downstream from the LEDs 20, a transmissive support 50 is arranged, comprising a luminescent material 51.

The transmissive support 50 may for instance be a PET film with a luminescent material coating 52 (i.e. a coating 52 comprising the luminescent material 51). The luminescent material 51 is arranged to absorb at least part of the LED emission 21 and emit luminescent material emission; the transmissive support 50 is disposed in a path of light emitted by the LED(s). The LED(s) 20 and the luminescent material 51 are arranged to generate light 13 of a predetermined colour, for instance white. The transmissive support 50 has an upstream face or side 53 and a downstream side 54.

The illumination device 10 further comprises a translucent exit window 60 arranged to transmit at least part of the light 13, thereby providing illumination device light 15. The translucent exit window 60 is especially arranged to diffuse the light 15 from the illumination device; the translucent exit window 60 is disposed in a path of light emitted by the luminescent material 51 and/or transmitted by the transmissive support 50. The translucent exit window may for instance be polycarbonate (PC) that is frosted. The translucent exit window 60 has an upstream face or side 63 and a downstream face or side 64.

Here, relative to the LED(s) 20, the transmissive support 50 is downstream from the LED(s) 20. The distance between the luminescent material 51 and LED(s) 20 is indicated with reference dLL (indicated in the figures with dip. Here, dLL is larger than 0 mm. Relative to the LED(s) 20, the translucent exit window 60 is again downstream from the transmissive support 50. The distance between the luminescent material 51 and the exit window 60 is indicated with reference dLW (indicated in the figures with dlw).

In this schematic embodiment, the translucent exit window 60 has a substantially flat shape and the transmissive support 50 also has a substantially flat shape.

In the schematic embodiment, the illumination device 10 has a LED chamber or LED cavity 11, enclosed by an LED support 30 supporting the LED(s), the transmissive support 50 and LED cavity walls 45. The LED support 30 may comprise a (metal core) PCB (printer circuit board) and an aluminium housing 32. At least part of the interior of the LED cavity 11, especially the LED cavity walls 45 and the support 30, may be provided with a reflective material, such as a reflective coating. The reflector is indicated with reference number 40. As reflector 40, for instance MCPET (microcellular polyethylene terephthalate) may be applied.

As mentioned above, the translucent exit window 60 is arranged downstream from the transmissive support 50 and the transmissive support 50 has upstream face 53 directed to the LED(s) 20 and downstream face 54 directed to the translucent exit window 60; the translucent exit window 60 has upstream face 63 directed to the downstream face 54 of the transmissive support 50 and a downstream face 64, directed to the exterior of the illumination device 10.

Since here the distance dLW between the luminescent material 51 and the exit window 60 is non-zero (here, the distance between transmissive support downstream face 54 and exit window upstream face 63 is also non-zero), there may be an(other) internal chamber or diffuser cavity. In the schematically depicted embodiment of FIG. 1a, this diffuser cavity is indicated with reference number 12. Here, the diffuser cavity 12 is enclosed by the transmissive support 50, the exit window 60 and the diffuser cavity walls 41. In a specific embodiment, between at least part of the luminescent material 51 and the exit window 60, here in fact between the transmissive support 50 and the exit window 60, more precisely, within diffuser cavity 12, a material may be arranged having an index of refraction equal to or smaller than 1.2, such as in the range of 1-1.2, like air, carbon dioxide, helium, argon or vacuum. In general, air will be applied.

In the schematic drawings 1a-1e, the luminescent material 51 is arranged upstream of the transmissive support 50, i.e. at the upstream face 53 of the transmissive support 50. However, as indicated above, also other configurations are possible, such as at the downstream face 54, or both at the upstream face 53 and downstream face 54 of the transmissive support 50 or contained in the transmissive support 50, or be the transmissive support 50 itself (luminescent ceramic, for instance).

FIG. 1b is a schematical figure of another embodiment of the illumination device 10. This embodiment is not substantially different from the embodiment schematically depicted in FIG. 1a (described above). However, the luminescent material translucent exit window distance dLW is larger than in the embodiment schematically depicted in FIG. 1a. In this embodiment, the diffuser cavity walls 41 of the diffuser cavity 12 are also provided with a reflector 40. Note that in FIGS. 1a and 1b, the diffuser cavity walls 41 and LED cavity walls 45 may be integral pieces.

In the schematic embodiments of FIGS. 1a and 1b, the upstream surface area of the transmissive support 50, indicated with reference AS1 and the upstream surface area of the translucent exit window 60, indicated with reference AEW1, are substantially the same (i.e. AEW1/AS1˜1).

FIGS. 1c-1e schematically depict embodiments wherein AEW1/AS1>1.

Referring to FIG. 1c, the schematically depicted embodiment of FIG. 1c is substantially identical to the schematically depicted embodiment of FIG. 1b (described above), except for the AEW1/AS1 ratio which is larger than 1. Further, the LED cavity 11 is enclosed by the substrate 30, the transmissive support 50, and LED cavity walls 45. Further, in the schematically depicted embodiment of FIG. 1c, the diffuser cavity 12 is enclosed by the transmissive support 50, the exit window 60, diffuser cavity walls 41, the LED support 30, and LED cavity wall 45.

Note that in the embodiments wherein the diffuser cavity 12 is at least partly enclosed by LED cavity walls 45, the external side of the LED cavity walls 45 may also be provided with a reflector 40 (not depicted).

FIG. 1d is another schematical drawing of an embodiment wherein AEW1/AS1>1. Here, the translucent exit window 60 has a substantially convex shape (“dome”) and the transmissive support 50 has a substantially flat shape. Note that dLW, i.e. the shortest distance between the luminescent layer 51 and the exit window 60, may be smaller at the edges of the transmissive support 50 than more in the centre of the transmissive support 50. Here, in the schematically depicted embodiment of FIG. 1d, the diffuser cavity 12 is enclosed by the transmissive support 50, the exit window 60, the LED support 30, and LED cavity wall 45. As mentioned above, note that the external side of the LED cavity walls 45 may also be provided with a reflector 40.

Finally, FIG. 1e is again another schematical drawing of an embodiment wherein AEW1/AS1>1. Here, the translucent exit window 60 has a substantially convex shape and the transmissive support 50 has a substantially convex shape (both “domes”). Note that dLW, i.e. the shortest distance between the luminescent layer 51 and the exit window 60, may in this case be substantially equal for each position on the transmissive support 50. Here, in the schematically depicted embodiments of FIG. 1e, the diffuser cavity 12 is enclosed by the transmissive support 50, the exit window 60, and the LED support 30. The LED cavity 11 is enclosed by the substrate 30 and the transmissive support 50. The LED cavity walls 45 and diffuser cavity walls 41 are absent in this embodiment, or can be assumed to be comprised by the transmissive support 50 and exit window 60, respectively.

FIG. 1f schematically depicts the embodiments of 1a or 1b in a perspective side view, in order to further illustrate these embodiments. Here the transmissive support 50 and the translucent exit window 60 are both circular (exit) windows, with upstream/downstream faces 53/54 and 63/64 respectively. The upstream face 53 of transmissive support 50 has an effective diameter DS1; the upstream face 63 of the translucent exit window 60 has an effective diameter DS2. The upstream face 53 of the transmissive support 50 has an area AS1 and the upstream face 63 of the translucent exit window 60 has an area AEW1.

The above described and schematically depicted embodiments are non-limiting. Other configurations are also possible. For instance, a substantially flat exit window 60 and a non-flat, for instance substantially convex, transmissive support 50 may also be an embodiment.

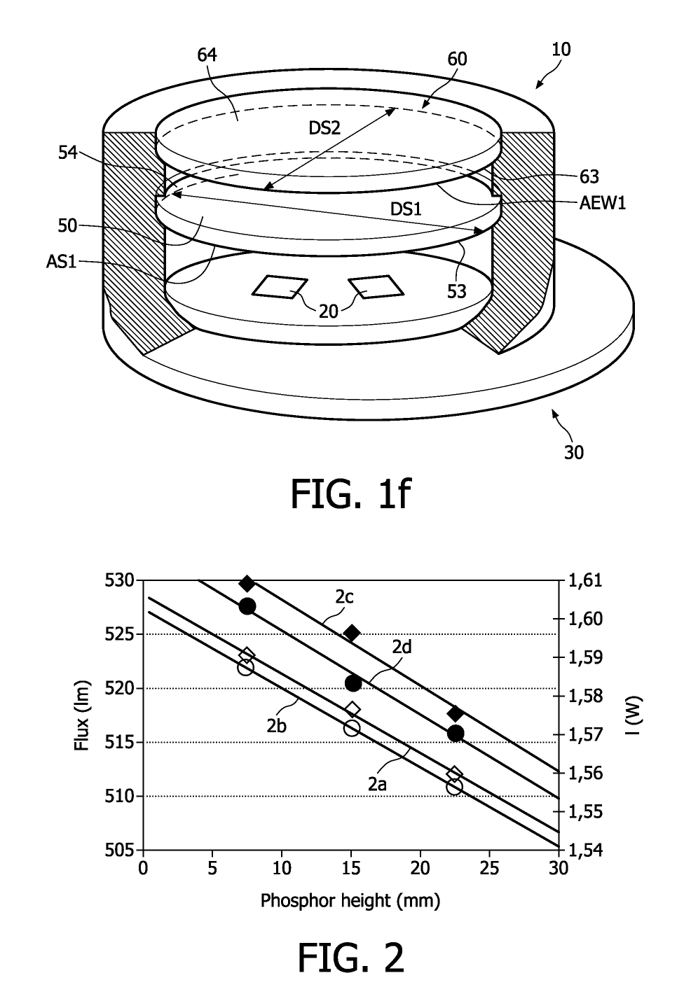

FIG. 2 depicts the influence of the position of the transmissive support 50 (comprising the luminescent material 51) on the light output in the case of an embodiment of an illumination device 10 with a substantially flat transmissive support 50 and a substantially flat translucent exit window 60, wherein both are circular with substantially the same diameters. The data 2a relate to the flux (in Lm) for an embodiment with the luminescent material arranged upstream from the transmissive support 50 (i.e. an upstream coating 52); the data 2b relate to the flux (in Lm) for an embodiment with the luminescent material arranged downstream from the transmissive support 50 (i.e. an downstream coating) (both left y-axis); the data 2c and 2d relate to the same systems but describe the radiative power (in W), respectively (both right y-axis). Here, blue emitting LEDs 20 and as luminescent material 51 a mixture of a cerium doped garnet and a europium doped nitride were applied in order to obtain white light 13. The figure depicts the influence of the position of the transmissive support 50 on the light output of this embodiment of the illumination device 10 as a function of dLL.

In another example, DS1 was fixed at 60 mm, AEW1/AS1 was fixed at 1, the LED 20 exit window 60 distance (i.e. substantially dLL+dLW) was fixed at 30 mm and the value of dLL was varied between 5 and 30 mm. The following results were obtained:

| dLL (mm) | CCT (K) |
|---|---|
| 7.5 | 2635 |
| 15 | 2664 |
| 22.5 | 2698 |
| 30 | 2719 |

It appears that the colour temperature can be adjusted depending upon the luminescent material LED distance dLL. Here, blue emitting LEDs 20 and as luminescent material 51 cerium doped garnets were applied in order to obtain white light 13.

Keeping the upstream surface area AEW1 of the translucent exit window 60 equal to the luminescent material surface area (for the sake of simplicity, herein the transmissive window upstream face area AS1 is taken) and increasing the distance dLW between both, ensuring a high diffuse reflectivity of the material that forms the wall 41 between the luminescent material 51 and the translucent exit window 60 (i.e. the walls 41 of diffuser cavity 12), results in a reduction of the saturation while the system efficacy is hardly reduced.

The reduction in saturation of the colour of the exit window 60 (in the off-state) appeared in an embodiment to be as follows: by increasing the distance dLW between the luminescent material 51 and the translucent exit window 60 from 0 to 80% of the diameter of the luminescent material area (here, again AS1 is taken), the saturation is reduced from about 50% to about 20%. Typically, in downlighting applications one would like to limit the aspect ratio to ca. 50% due to volume constraints. Therefore it is advantageous to mount the luminescent material 51 relative close to the LED(s) 20.

Another concern in the application of LEDs 20 and remote luminescent material 51 is the homogeneity of the illumination device light 15. To achieve sufficient homogeneity at the exit window 60, the translucent exit window 60 should preferably be placed at a sufficiently large distance from the LED(s) 20: typically at least 1.5 times the pitch between the LEDs, such as in the order of about 1.5-5 times the distance (pitch) between the LEDs. Mounting the transmissive support comprising the luminescent material near the LEDs 20 that may emit light inhomogeneously, and mounting a translucent exit window 60 at some distance from the luminescent material 51, results in excellent homogeneity of the light 15 emitted from the translucent exit window 60, and at the same time optimises the remote luminescent material 51 efficiency.

Prototype lamps have been built with a frosted glass bulb as translucent exit window 60 around a 30 mm diameter remote luminescent material module. Flux measurements showed that the light loss due to the application of the translucent bulb was limited to 5%, while the lamp looked perfectly white in off-state.

As another example of a prototype lamp according to the invention, a module 10 arranged for down lighting consists of a LED-PCB in cavity 11 (optical chamber or mixing chamber). The LED PCB, a series of blue LEDs on a support 30 generates blue light. Bottom and diffuser cavity wall of the cavity 12 is covered with a high reflective material (e.g. MCPET, E60L) to ensure good mixing and recycling of the light; the exit window of the optical chamber consists of a diffuser, shaping the beam to a lambertian radiation pattern. Inside the mixing chamber 12, a transmissive support 50 with luminescent material 51 is placed, partly converting the blue light from the LEDs 20 to yellow/green/red and partly transmitting the blue in such a way that the light 15 exiting the module 10 has the desired colour. The LED PCB is positioned on a heatspreader, used to connect the module with heatsinks to ensure proper thermal management. A LED driver powers the LED module with the desired current. The LED driver can be fixed output, but can also be dimmable. A reflector can be placed at the exit aperture of the module 10 to generate a desired beam pattern. At the housing of the module 10, various fixation points have been added to fix heatsinks, reflectors and luminaire housing parts to the module.

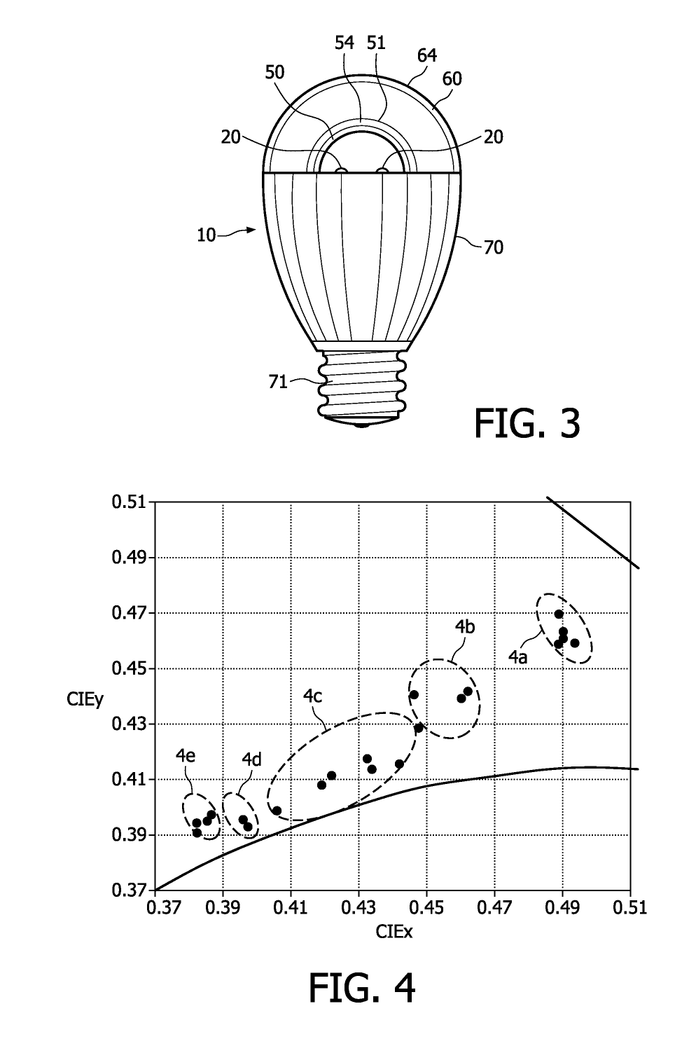

In another example of a prototype lamp according to the invention, an incandescent retrofit lamp was designed. An example is schematically shown in FIG. 3. The bulb lamp is made up of the following parts and materials. The lamp socket is usually made up of metal with insulation and similar to traditional bulb lamps. The lamp housing is made of metal or plastic and incorporates the required electronics to power the LED(s) 20. The housing is also used as heat sink (indicated with reference 70) i.e. it is designed such as to carry away heat generated in the lamp by the LED(s) 20, driver and luminescent material 51. For this purpose it can have vertical fins. The upper surface of the housing can be made highly reflective, e.g. white or metallic. The LED(s) 20, and optionally other light sources, are placed in the top region of the lamp with possibly highly reflective material (e.g. white plastic or MCPET) around them for increased performance (as in FIG. 1e). The luminescent material 51 on a transmissive support is placed over the LEDs. The luminescent material 51 can be coated on the transmissive support 50 or incorporated in the transmissive support 50. The transmissive support 50 can be made of glass, plastic e.g. PC, or any other transmissive material. The outer bulb (exit window 60) is placed on top of the housing and can be made of glass, plastic or other (semi)transparent material. A certain level of diffusivity is introduced to the bulb using either coatings or additives to the base material during production. Further, the illumination device 10 may have a cap 71.

A further series of devices was made, of which the results are depicted in FIG. 4. The x,y CIE values of the colour of the lamp in the off state under office (TL) illumination was measured. The most right data, indicated with 4a, relate to devices wherein the luminescent material was provided on the downstream face of different types of exit windows. Data 4b relate to devices wherein the luminescent material was provided on the upstream face of different types of exit windows. The data in the oval part, 4c, relate to a number of embodiments wherein the luminescent material was provided on transmissive supports, respectively, at different distances dLW from the exit window, respectively, wherein the device further comprises a translucent exit window according to the invention, and wherein dLW ranges from 10% to 80% of the exit window diameter DS2, where the data points with the larger CIE x values correspond with the smaller dLW values. The date in circle 4d were obtained with a relative large mean distance between the luminescent material and the exit window albeit with a small minimum distance, and therefore a small value of dLW; the difference between 4c and 4d being, however, that the ratio AEW1/AS1 in the 4c embodiments is substantially 1, wherein the AEW1/AS1 in the 4d embodiments is larger than 1. The data indicated with circle 4e relate to the same type of embodiments as indicated with 4d; the difference between 4d and 4e being, however, that 4d has a frosted exit window 60 and a transmissive support 50 that is transparent, and the embodiments of 4e have a frosted exit window 60 and a transmissive support 50 that is (also) translucent (frosted polycarbonate) with the luminescent material 51 provided at the upstream face of the transmissive support. Hence, in a specific embodiment, also the transmissive support 50 is translucent.

In a number of the above schematically depicted embodiments, the transmissive support 50 and the exit window 60 are depicted as circular and substantially flat features (see FIGS. 1a-1c; and the transmissive support 50 in FIG. 1d). Especially assuming a substantially flat transmissive support 50, the transmissive support 50 may be substantially circular but in another embodiment may also be square, or may have also other shapes, known to the person skilled in the art. Likewise, especially assuming a substantially flat exit window 60, the exit window 60 may be circular or may in another embodiment be square, or may have also other shapes, known to the person skilled in the art.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The devices herein are amongst others described during operation. For instance, the term “blue LED” refers to an LED which during operation thereof generates blue light; in other words: the LED is arranged to emit blue light. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. An illumination device comprising a light emitting diode (LED) arranged to emit LED emission, a transmissive support comprising a luminescent material, wherein the luminescent material is arranged to absorb at least part of the LED emission and emit luminescent material emission, wherein the LED and the luminescent material are arranged to generate light of a predetermined colour, wherein the illumination device further comprises a translucent exit window arranged to transmit at least part of the light, wherein, relative to the LED, the transmissive support is downstream from the LED, thereby providing a luminescent material LED distance (dLL), and the translucent exit window is downstream from the transmissive support, thereby providing a luminescent material exit window distance (dLW), wherein the translucent exit window has an upstream face with an exit window upstream face area (AEW1) and that the transmissive support has an upstream face with an transmissive support upstream face area (AS1), wherein exit window and transmissive support have a surface area ratio AEW1/A51 in the range of 2-20.

2. The illumination device according to claim 1, wherein between at least part of the luminescent material and the exit window, a material is arranged having an index of refraction equal to or smaller than 1.2.

3. The illumination device according to claim 1, wherein the transmissive support comprises an organic material selected from the group consisting of: PET (polyethylene terephthalate), PE (polyethylene), PP (polypropylene), PC (polycarbonate), P(M)MA (poly(methyl)metacrylate), PEN (polyethylene napthalate) and PDMS (polydimethylsiloxane).

4. The illumination device according to claim 1, wherein the transmissive support comprises an inorganic material selected from the group consisting of glasses, fused quartz, ceramics, and silicones.

5. The illumination device according to claim 1, wherein at least part of the luminescent material comprises a transmissive ceramic luminescent material, and wherein the transmissive support comprises the transmissive ceramic luminescent material.

6. The illumination device according to claim 1, wherein the luminescent material LED distance (dLL) is adjustable.

7. The illumination device according to claim 1, wherein the luminescent material LED distance (dLL) is in the range of 0.5-50 mm.

8. The illumination device according to claim 1, wherein the luminescent material exit window distance (dLW) is in the range of 0.01-100 mm.

9. The illumination device according to claim 1, wherein the transmissive support has an upstream face comprising a coating, wherein the coating comprises at least part of the luminescent material.

10. (canceled)

11. The illumination device according to claim 1, wherein the transmissive support has an upstream face with an effective transmissive support upstream face diameter (DS1), wherein the ratio dLL/DS1 is in the range of 0.01-1.

12. The illumination device according to claim 1, wherein the transmissive support has an upstream face with an effective transmissive support upstream face diameter (DS1), wherein the ratio dLW/DS1 is in the range of 0.01-1.

13. The illumination device according to claim 1, wherein the translucent exit window has a substantially convex shape.

14. The illumination device according to claim 1, wherein the transmissive support has a substantially convex shape.

15. The illumination device according to claim 1, wherein the translucent exit window has a substantially flat shape.

16. The illumination device according to claim 1, wherein the transmissive support has a substantially flat shape.

17. The illumination device according to claim 1, wherein the illumination device comprises a plurality of light emitting diodes (LEDs arranged to emit LED emission.

18. A method for tuning the colour point of the light of an illumination device according to claim 1, wherein the luminescent material LED distance (dLL) is adjustable, and wherein, during operation of the light emitting diode (LED) and optionally in the absence of the translucent exit window, the luminescent material LED distance (dLL) is adjusted until a predetermined colour point is sensed by a sensor arranged to sense the light generated by the LED and the luminescent material.

19. A method for tuning the colour point of the light of an illumination device according to claim 1, wherein the transmissive support comprises a non-uniform distribution of the luminescent material, wherein the transmissive support is movable, and wherein, during operation of the light emitting diode (LED) and optionally in the absence of the translucent exit window, the position of the transmissive support relative to the LED is adjusted until a predetermined colour point is sensed by a sensor arranged to sense the light generated by the LED and the luminescent material.
